(19) United States
(12) Patent Application Publication
(10) Pub. No.: US 2026/0255448 A1
(43) Pub. Date: Aug. 27, 2026

(54) CERAMIC HEATER

(71) Applicant: Niterra Co., Ltd., Nagoya-shi (JP)

(72) Inventors: Hiroki HATTORI, Nagoya-shi (JP); Kazuki TANIZAWA, Nagoya-shi (JP)

(73) Assignee: Niterra Co., Ltd., Nagoya-shi (JP)

(21) Appl. No.: 19/462,206

(22) Filed: Jan. 28, 2026

(30) Foreign Application Priority Data
Feb. 26, 2025 (JP) 2025-028840

(51) Int. Cl. H05B 3/48

(52) U.S. Cl. CPC H05B 3/48; H05B 2203/021

(57) ABSTRACT

To improve resistance to thermal shock. A ceramic heater 11 is a ceramic heater 11 for heating liquids, and includes: a ceramic body 22 that includes a base 21 made of ceramic and extending in a longitudinal direction, and a resistive heating element 23 formed on a surface of the base 21; and a resin layer 29 configured to cover a region R1 that includes the resistive heating element 23 in the longitudinal direction on an outer surface 22A of the ceramic body 22. The resin layer 29 is heat resistant to temperatures higher than a heating temperature of the ceramic body 22.

### BACKGROUND

### 1. Field of the Disclosure

The present disclosure relates to a ceramic heater.

### 2. Description of Related Art

To date, an electric heating type hot water heating apparatus disclosed in Patent Document 1 has been known. The electric heating type hot water heating apparatus in Patent Document 1 includes a case having an inlet port, a flow path, and an outlet port for a heat transfer medium, and a ceramic heater disposed in the flow path. The ceramic heater includes a support member made of ceramic such as alumina, silicon nitride, aluminum nitride, or silicon carbide, and a heating element buried in a side surface of the support member.

[Patent Document 1] Japanese Patent Application Laid-Open (kokai) No. 2013-126844.

For example, when boiling occurs on the surface of the ceramic heater, an air layer is formed. The ceramic heater is rapidly heated at the air layer, which causes a high-temperature region to be formed. When a liquid heating medium comes into contact with the high-temperature region, the ceramic heater is likely to crack. Thus, the ceramic heater is vulnerable to thermal shock and tends to crack easily. Therefore, the ceramic heater needs to have increased resistance to thermal shock for use as a heat exchanger.

### SUMMARY OF THE DISCLOSURE

The present disclosure has been made in view of the above circumstances, and an object of the present disclosure is to improve resistance to thermal shock.

A ceramic heater of the present disclosure is a ceramic heater for heating liquids, and includes: a ceramic body that includes a base that is made of ceramic and extends in a longitudinal direction, and a resistive heating element that is formed on a surface of the base; and a resin layer configured to cover a region that extends in the longitudinal direction so as to include at least the resistive heating element on an outer surface of the ceramic body. The resin layer is heat resistant to temperatures higher than a heating temperature of the ceramic body.

Accordingly, the ceramic heater of the present disclosure can improve resistance to thermal shock.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 is a cross-sectional view showing the entire configuration of a ceramic heater according to embodiment 1.

FIG. 2 is a cross-sectional view showing the internal structure of the ceramic heater.

FIG. 3 is a view illustrating a manufacturing process for an insulation tube.

FIG. 4 is an enlarged cross-sectional view of an area enclosed by an alternate long and short dash line in FIG. 2.

FIG. 5 is a perspective view showing a ceramic heater according to embodiment 2.

FIG. 6 is a perspective view showing a ceramic heater according to embodiment 3.

### DESCRIPTION OF REFERENCE NUMERALS

10: heat exchanger

11, 12, 13: ceramic heater

20: insulation tube

20A: ceramic tube

21, 121, 221: base

22, 122, 222: ceramic body

22A: outer surface

23: resistive heating element

24: internal terminal

25: terminal portion

26: ceramic sheet

27: conductor layer

28: heating portion

29, 129, 229: resin layer

29A: inner resin layer

29B: outer resin layer

30: first flange

40: second flange

60: housing

70: third housing

80: second housing

90: first housing

AX: axis

T1: average thickness

D1: distance

FC: flow channel

R1, R2, R3: region

### DETAILED DESCRIPTION

First, embodiments of the present disclosure will be listed and described.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus 10% of the particular term, and “substantially” and “significantly” will mean plus or minus 10% of the particular term.

(1) A ceramic heater of the present disclosure is a ceramic heater for heating liquids, and includes, for example: a ceramic body that includes a base that is made of ceramic and extends in a longitudinal direction, and a resistive heating element that is formed on a surface of the base; and a resin layer configured to cover a region that extends in the longitudinal direction so as to include at least the resistive heating element on an outer surface of the ceramic body. The resin layer is heat resistant to temperatures higher than a heating temperature of the ceramic body.

In this configuration, since the surface of the ceramic body is covered by the resin layer, the thermal conductivity between a liquid heating medium and the ceramic body is reduced due to the resin layer. Therefore, even when the difference in temperature between the liquid heating medium and the ceramic body is large, the ceramic body can be prevented from being rapidly cooled by the liquid heating medium. This improves cracking and resistance to thermal shock.

(2) A ceramic heater of the present disclosure is a ceramic heater for heating liquids, and includes, for example: a ceramic body that includes a base that is made of ceramic, has a rod-like shape, and extends in a longitudinal direction, and a resistive heating element that is embedded in the base; and a resin layer configured to cover a region extending in the longitudinal direction so as to include at least the resistive heating element on an outer surface of the ceramic body. The resin layer is heat resistant to temperatures higher than a heating temperature of the ceramic body. This configuration also improves cracking and resistance to thermal shock.

(3) In the ceramic heater described in (1) above, an average thickness of the resin layer may be thinner than a distance from the resistive heating element to the outer surface.

When the average thickness of the resin layer is thicker than the distance from the resistive heating element to the outer surface, heat transfer to the liquid heating medium may become less efficient. On the other hand, when the average thickness of the resin layer is thinner than the distance from the resistive heating element to the outer surface, it is possible to improve resistance to thermal shock while maintaining the performance of heat transfer to the liquid heating medium.

(4) In the ceramic heater described in any one of (1) to (3) above, the resin layer may include an inner resin layer that directly covers a surface of the ceramic body, and an outer resin layer that covers the surface of the ceramic body via the inner resin layer, and main components (e.g., the resin) of the inner resin layer and the outer resin layer are different from each other.

The inner resin layer may be a heat-resistant resin layer, and the outer resin layer may be a resin layer having high mechanical strength and thermal conductivity. The resin layers may have multiple functions.

(5) In the ceramic heater described in any one of (1) to (4) above, a heat resistance temperature of the resin layer may be 150°C or higher.

Water, coolant liquids, and the like are widely used as heating media. Since the boiling point of water is 100°C and the boiling point of coolant liquid is approximately 120°C, it is assumed that the resin layer may reach a temperature of 100°C or higher when an air layer is formed due to boiling. In this case, the resin layer can withstand heat up to 150°C.

As resins having a heat resistance temperature of 150°C or higher, super engineering plastics such as aromatic polyamide (PPA), polyphenylene sulfide (PPS), liquid crystal polymer (LCP), polysulfone (PSU), polyether sulfone (PES), polyetherimide (PEI), polyamide imide (PAI), polyether ether ketone (PEEK), polytetrafluoroethylene (PTFE), and combinations thereof can be used.

(6) In the ceramic heater described in any one of (1) to (5) above, the resin layer may include known fillers, such as, for example, glass fibers.

Including glass fibers in the resin layer, for example, can enhance heat resistance and improve strength.

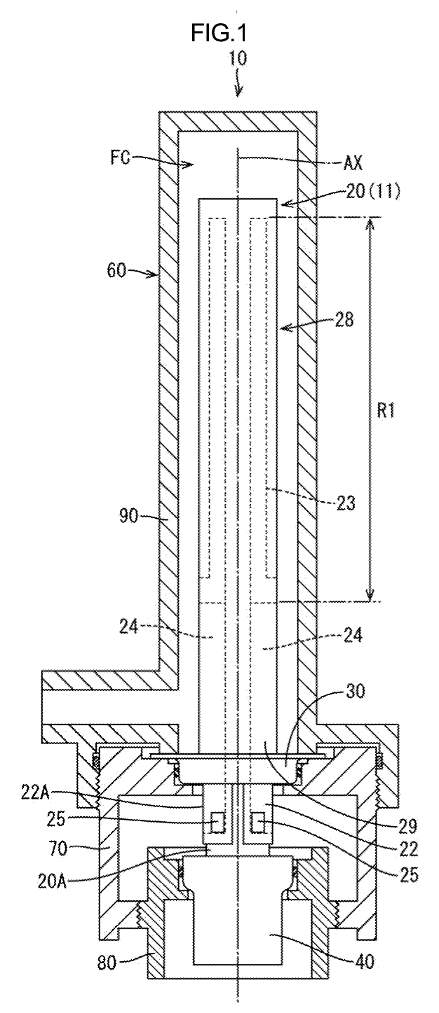

An embodiment of the present disclosure will now be described with reference to FIGS. 1 to 4. The present disclosure is not limited to these examples, but is indicated by the claims, and is intended to include all modifications within the meaning and scope equivalent to the claims. In the following description, for a plurality of identical members, one member may be designated by a reference numeral and reference numerals for the other members may be omitted.

### Embodiment 1

### Heat exchanger

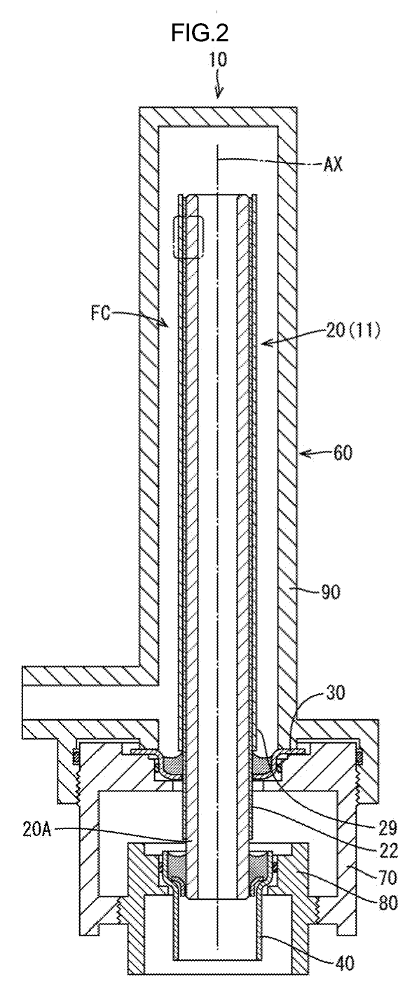

A heat exchanger 10 according to the present embodiment is a device that heats liquids such as water or coolant liquids serving as heating media. For example, the heat exchanger 10 may be mounted in a vehicle such as an electric vehicle (EV), and may be used for cabin heating or battery warming. As shown in FIG. 1 and FIG. 2, the heat exchanger 10 includes a ceramic heater 11, and a housing 60 that accommodates the ceramic heater 11.

### Ceramic heater

The ceramic heater 11 includes an insulation tube 20, a first flange 30, a second flange 40, and terminal portions 25. The insulation tube 20 has a cylindrical shape centered around an axis AX. The insulation tube 20 extends in the longitudinal direction (a direction in which the axis AX extends). The insulation tube 20 includes a ceramic tube 20A made of ceramic and having a cylindrical shape, a ceramic body 22 having a cylindrical shape and disposed around the outer circumference of the ceramic tube 20A, and a resin layer 29 that covers an outer circumferential surface 22A of the ceramic body 22. The ceramic body 22 includes a base 21 made of ceramic and extending in the longitudinal direction, and a resistive heating element 23 and a pair of internal terminals 24 formed at a surface of the base 21. The base 21 is made of, for example, a ceramic material such as alumina.

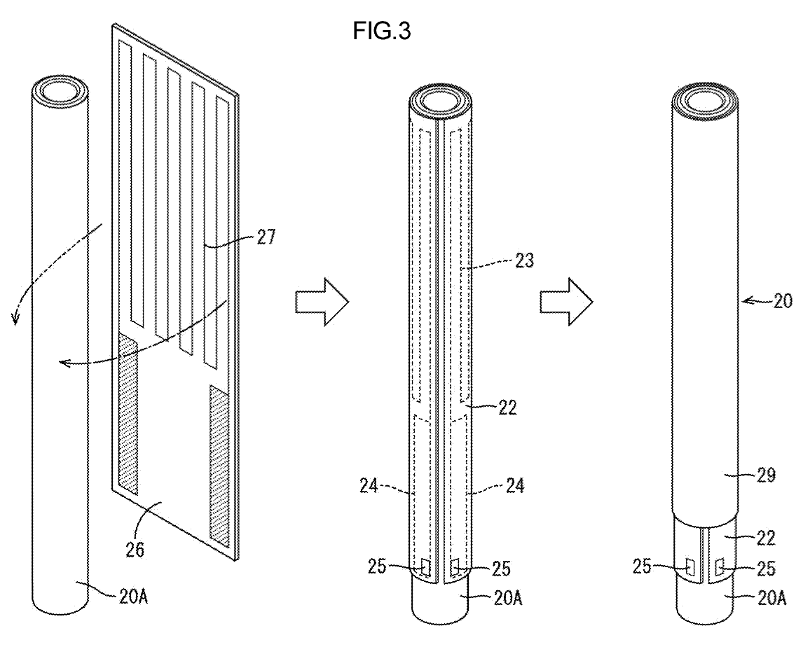

As shown in FIG. 3, the resistive heating element 23 and the pair of internal terminals 24 are formed on the inner circumferential surface (the surface on the ceramic tube 20A side) of or within the ceramic body 22. The resistive heating element 23 is shown having a meandering thin wire-like shape, but may have a different shape. The internal terminals 24 each have a rectangular shape that is wider as compared to the resistive heating element 23. The internal terminals 24 are electrically connected to the terminal portions 25 through via-conductors (not shown). The terminal portions 25 are formed on the outer circumferential surface of the ceramic body 22.

The insulation tube 20 can be manufactured by, for example, winding a ceramic sheet 26 around the ceramic tube 20A calcined in advance and then firing these. Conductor layers 27 made of tungsten or the like are formed on the surfaces or inside of the ceramic sheet 26. After firing, the ceramic sheet 26 serves as the base 21 forming the ceramic body 22. After firing, the conductor layers 27 serve as the resistive heating element 23, the internal terminals 24, and the terminal portions 25.

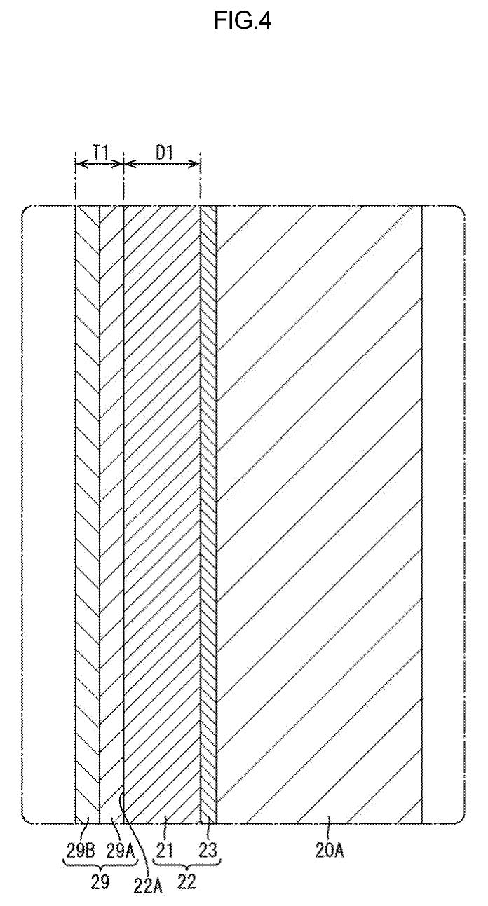

The resin layer 29 is configured to cover a region R1 that includes at least the resistive heating element 23 in the longitudinal direction on an outer surface 22A of the ceramic body 22. The resin layer 29 is heat resistant to temperatures higher than the heating temperature of the ceramic body 22. The heating temperature refers to the temperature of the ceramic body 22 during heating by the resistive heating element 23. As shown in FIG. 4, an average thickness T1 of the resin layer 29 is thinner than a distance D1 from the resistive heating element 23 to the outer surface 22A.

The resin layer 29 may include an inner resin layer 29A that directly covers the outer surface 22A of the ceramic body 22, and an outer resin layer 29B that covers the outer surface 22A of the ceramic body 22 via the inner resin layer 29A. In this case, the main components (e.g., the resin) of the inner resin layer 29A and the outer resin layer 29B are preferably different from each other.

The heat resistance temperature of the resin layer 29 is 150°C or higher. As resins having a heat resistance temperature of 150°C or higher, super engineering plastics such as aromatic polyamide (PPA), polyphenylene sulfide (PPS), liquid crystal polymer (LCP), polysulfone (PSU), polyether sulfone (PES), polyetherimide (PEI), polyamide imide (PAI), polyether ether ketone (PEEK), and polytetrafluoroethylene (PTFE) can be used.

The resin layer 29 may include known fillers, such as glass fibers, and this means that one or both of the inner resin layer 29A and the outer resin layer 29B may have the filler.

### Housing

As shown in FIGS. 1 and 2, the housing 60 accommodates the ceramic heater 11. The housing 60 forms a part of a flow channel FC through which liquid flows. The ceramic heater 11 is shown fixed to the housing 60 in a watertight state via the first flange 30. In addition, the ceramic heater 11 is shown fixed to the housing 60 via the second flange 40. Specifically, the ceramic heater 11 may be fixed to the housing 60 in a watertight state via the second flange 40. Here, being fixed in a watertight state means that a plurality of members are fixed together by a fixing portion and liquid leakage via the fixing portion is prevented.

The housing 60 may include a third housing 70, a second housing 80, and a first housing 90, each of which is formed individually. The third housing 70 is assembled to the second housing 80. The first housing 90 is assembled to the third housing 70. The third housing 70 is fitted to the first flange 30 in a watertight state. The second housing 80 is fitted to the second flange 40 in a watertight state. Here, being fitted in a watertight state means that a plurality of members are fitted at a fitting portion and liquid leakage via the fitting portion is prevented.

### Effect of Embodiment 1

As described above, the ceramic heater 11 of embodiment 1 is a ceramic heater 11 for heating liquids, and includes: the ceramic body 22 that includes the base 21 made of ceramic and extending in the longitudinal direction, and the resistive heating element 23 formed at the surface of the base 21; and the resin layer 29 configured to cover a region that includes at least the resistive heating element 23 in the longitudinal direction on the outer surface 22A of the ceramic body 22. The resin layer 29 is heat resistant to temperatures higher than the heating temperature of the ceramic body 22.

In this configuration, since the outer surface 22A of the ceramic body 22 is covered by the resin layer 29, the thermal conductivity between the liquid heating medium and the ceramic body 22 is reduced due to the resin layer 29. Therefore, even when the difference in temperature between the liquid heating medium and the ceramic body 22 is large, the ceramic body 22 can be prevented from being rapidly cooled by the liquid heating medium and thus cracking, and resistance to thermal shock can be improved.

The average thickness T1 of the resin layer 29 is preferably thinner than the distance D1 from the resistive heating element 23 to the outer surface 22A. For example, the resin layer 29 may be configured such that, in terms of thickness, T1 < D1. In some aspects, in terms of thickness, T1 may be about 90% D1 or less, about 75% D1 or less, about 50% D1 or less, about 25% D1 or less, or about 10% D1 or less.

If the average thickness T1 of the resin layer 29 is thicker than the distance D1 from the resistive heating element 23 to the outer surface 22A, there is a concern that heat transfer to the liquid heating medium may become less efficient. On the other hand, in the above configuration, since the average thickness T1 of the resin layer 29 is thinner than the distance D1 from the resistive heating element 23 to the outer surface 22A, it is possible to improve resistance to thermal shock while maintaining the performance of heat transfer to the liquid heating medium.

The resin layer 29 may include both the inner resin layer 29A that directly covers the surface of the ceramic body 22 and the outer resin layer 29B that covers the surface of the ceramic body 22 via the inner resin layer 29A, and the main components (e.g., the resin and/or the filler) of the inner resin layer 29A and the outer resin layer 29B may be different from each other.

The inner resin layer 29A may be a heat-resistant resin layer, and the outer resin layer 29B may be a resin layer having high mechanical strength and thermal conductivity, so that the resin layers may have multiple functions.

A thickness ratio (i.e., 29A/29B) of the inner and outer resin layers 29A and 29B is not particularly limited, but may be about 0.90/0.10, or about 0.75/0.25, or about 0.50/0.50, about 0.25/0.75, or about 0.10/0.90.

The heat resistance temperature of the resin layer 29 may be 150°C or higher. In some aspects, the heat resistance temperature of the resin layer 29 may be about 175°C or higher, or about 200°C or higher, or about 225°C or higher, or about 250°C or higher.

Water, coolant liquids, and the like are widely used as heating media. Since the boiling point of water is 100°C and the boiling point of coolant liquid is approximately 120°C, it is assumed that the resin layer 29 may reach a temperature of 100°C or higher when an air layer is formed due to boiling. In this case, the resin layer 29 can withstand heat up to 150°C.

The resin layer 29 may include a filler, such as glass fibers.

Including glass fibers in the resin layer 29 can enhance heat resistance and improve strength.

<Embodiment 2>

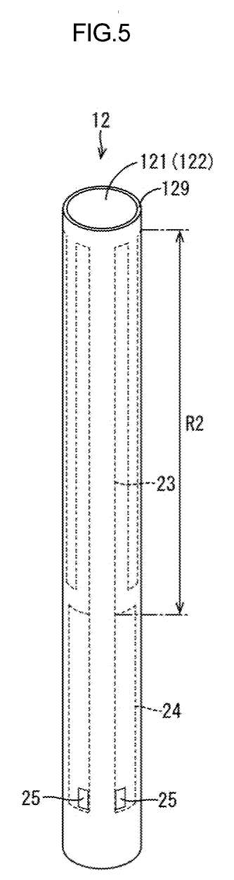

Embodiment 2 will be described with reference to FIG. 5. A ceramic heater 12 of embodiment 2 includes a ceramic body 122 and a resin layer 129, and has a rod-like shape, unlike the ceramic heater 11 of embodiment 1. The ceramic body 122 includes a base 121 made of ceramic and extending in the longitudinal direction, and the resistive heating element 23. The resistive heating element 23 is embedded in the base 121 that has a rod-like shape and extends in the longitudinal direction. The resin layer 129 is configured to cover a region R2 that includes at least the resistive heating element 23 in the longitudinal direction on the outer surface of the ceramic body 122. The same components as those in embodiment 1 are denoted by the same reference numerals as in embodiment 1, and the descriptions thereof are omitted.

<Embodiment 3>

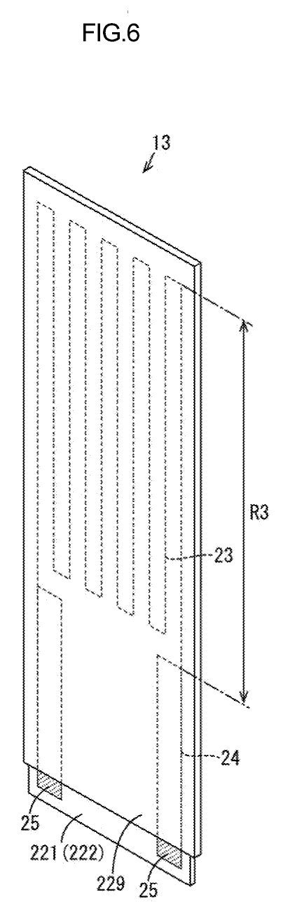

Embodiment 3 will be described with reference to FIG. 6. A ceramic heater 13 of embodiment 3 includes a ceramic body 222 and a resin layer 229, and has a plate-like shape, unlike the ceramic heater 11 of embodiment 1. The ceramic body 222 includes a base 221 that is made of ceramic and extends in the longitudinal direction, and the resistive heating element 23. The resistive heating element 23 is formed on a surface of the base 221 having a plate-like shape and extending in the longitudinal direction. The resin layer 229 is configured to cover a region R3 that includes at least the resistive heating element 23 in the longitudinal direction on an outer surface of the ceramic body 222. The same components as those in embodiment 1 are denoted by the same reference numerals as in embodiment 1, and the descriptions thereof are omitted.

<Other embodiments>

(A) In embodiments 1 to 3 above, the average thickness T1 of the resin layer 29 is thinner than the distance D1 from the resistive heating element 23 to the outer surface 22A, but the average thickness of the resin layer 29 may be equal to or thicker than the distance D1. For example, in terms of thickness, T1 may be about 110% D1 or more, about 125% D1 or more, about 150% D1 or more, etc.

(B) In embodiments 1 to 3 above, the resin layer 29 is composed of the inner resin layer 29A and the outer resin layer 29B, but the resin layer may be composed of a single layer or three or more layers.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2025-028840 filed February 26, 2025, the disclosure of which is incorporated herein by reference in its entirety.

What is claimed is:

1. A ceramic heater for heating liquids, the ceramic heater comprising:
a ceramic body that includes a base that is made of ceramic and extends in a longitudinal direction, and a resistive heating element that is formed on a surface of the base; and
a resin layer configured to cover a region that includes at least the resistive heating element in the longitudinal direction on an outer surface of the ceramic body, wherein
the resin layer is heat resistant to temperatures higher than a heating temperature of the ceramic body.

2. A ceramic heater for heating liquids, comprising:
a ceramic body that includes a base that is made of ceramic, has a rod-like shape, and extends in a longitudinal direction, and a resistive heating element embedded in the base; and
a resin layer configured to cover a region that includes at least the resistive heating element in the longitudinal direction on an outer surface of the ceramic body, wherein
the resin layer is heat resistant to temperatures higher than a heating temperature of the ceramic body.

3. The ceramic heater according to claim 1, wherein an average thickness of the resin layer is thinner than a distance from the resistive heating element to the outer surface.

4. The ceramic heater according to claim 1, wherein
the resin layer includes an inner resin layer that directly covers the surface of the ceramic body, and an outer resin layer that covers the surface of the ceramic body via the inner resin layer, and
a main component of the inner resin layer and the outer resin layer are different from each other.

5. The ceramic heater according to claim 1, wherein a heat resistance temperature of the resin layer is 150°C or higher.

6. The ceramic heater according to claim 1, wherein the resin layer includes glass fibers.

7. The ceramic heater according to claim 2, wherein a heat resistance temperature of the resin layer is 150°C or higher.

8. The ceramic heater according to claim 2, wherein the resin layer includes glass fibers.
